(19) United States
(12) Patent Application Publication
(10) Pub. No.: US 2019/0084584 A1
(43) Pub. Date: Mar. 21, 2019

(54) DEVICE AND SYSTEM FOR WARNING A DRIVER OF AN INCOMING BACK AND LATERAL VEHICLE

(71) Applicant: SANWEI JEFFREY FAN, Perris, CA (US)

(72) Inventor: SANWEI JEFFREY FAN, Perris, CA (US)

(21) Appl. No.: 16/056,573

(22) Filed: Aug. 7, 2018

(30) Foreign Application Priority Data
Sep. 18, 2017 (TW) 106131989

(51) Int. Cl. B60W 50/14; B60W 30/095; B60Q 9/00; B60R 1/00; G06F 15/18

(52) U.S. Cl. CPC B60W 50/14; B60W 30/0956; B60Q 9/008; B60R 1/00; B60R 2300/8093; B60W 2050/146; B60W 2550/308; B60R 2300/802; G06F 15/18

(57) ABSTRACT

Disclosed are a device and a system for warning a driver of an incoming back and lateral vehicle. The device or system captures a wide-angle 180-degree image of view behind a driver's shoulders to analyze and classify the image through a machine learning technique and determine whether there is a potential threat to the driver. If there is a threat, the device or system will warn the driver, thus improving the driver's safety dramatically. Moreover, Darknet is used to provide a faster response in the prediction of threats through image processing and classification.

### BACKGROUND OF THE INVENTION

### Field of the Invention

The present invention relates to driving safety, in particular to a device and system for warning a driver of an incoming back and lateral vehicle.

### Description of Realted Art

In the field of conventional driving safety, a driver of a motor vehicle (particularly a motorcycle) often pays attention to incoming vehicles from the front only, and has difficulty to alert vehicles approaching from the rear, thus often leading to horrible accidents. Even if a camera is installed at the rear of the motor vehicle, the camera may be used for the purposes of monitoring and videotaping only, but it is unable to give warning signals to the driver proactively. Therefore, the driver will be distracted while watching and monitoring the images of the front and the rear, which may lead to accidents easily.

In view of the aforementioned drawback of the conventional way of monitoring the image of the rear, the present invention provides a device and system for warning a driver of an incoming back and lateral vehicle to overcome the drawback of the prior art.

### SUMMARY OF THE INVENTION

Therefore, it is a primary objective of the present invention to provide a device of warning the driver for an incoming vehicle approaching from the rear or both sides, and the device comprises an image capture unit for capturing an image in a rear semicircular or rear hemispherical region behind a driver's shoulders; a processing unit coupled to the image capture unit for receiving the image through a computer programming language, identifying and analyzing the image by a machine learning technique, classifying the image through an artificial neural network, and determining whether there is a potential threat indicated in the image; and a warning unit coupled to the processing unit for warning the driver.

The present invention further provides a system of warning a driver for an incoming vehicle approaching from the rear or both sides, and the system comprises a monitoring and warning device and the Internet, and the monitoring and warning device comprises an image capture unit for capturing an image in a rear semicircular or rear hemispherical region behind a driver's shoulders; a transmission unit coupled to the image capture unit; a warning unit coupled to the transmission unit for warning the driver; and the Internet connected to the transmission unit via wireless connection to obtain the image, wherein the image is received through the Internet by a computer programming language, identified and analyzed by a machine learning technique, classified through an artificial neural network, and determined whether there is a potential threat indicated in the image, and the transmission unit is provided for transmitting a command to the warning unit to warn the driver when there is a threat indicated in the image.

To achieve the aforementioned and other objectives, the present invention provides a device of warning a driver for an incoming vehicle approaching from the rear or both sides, and the device further comprises a storage unit coupled to the processing unit for storing the computer programming language, the machine learning technique, the artificial neural network, the image or a combination of the above.

The device of warning a driver for an incoming vehicle approaching from the rear or both sides according to the present invention further comprises a transmission unit coupled to the processing unit, and connected to the Internet via wireless connection for transmitting the stored computer programming language, the machine learning technique, the artificial neural network, and the image or any combination of the above to the processing unit.

In the device of warning a driver for an incoming vehicle approaching from the rear or both sides according to the present invention, the image capture unit is combined with a wearable device.

In the device of warning a driver for an incoming vehicle approaching from the rear or both sides according to the present invention, the computer programming language is a Python programming language used in a convolutional neural network.

In the device of warning a driver for an incoming vehicle approaching from the rear or both sides according to the present invention, the machine learning technique is an open source software technique.

In the device of warning a driver for an incoming vehicle approaching from the rear or both sides according to the present invention, the artificial neural network is Darknet.

In the device of warning a driver for an incoming vehicle approaching from the rear or both sides according to the present invention, the processing unit is provided for identifying and analyzing a motor vehicle in the image, marking the image, and driving the warning unit to warn the driver.

In a system of warning a driver for an incoming vehicle approaching from the rear or both sides according to the present invention, the Internet is provided for identifying and analyzing a motor vehicle in the image, marking the image, and driving the warning unit to warn the driver.

Compared with the prior art, the present invention overcome the difficulty for the conventional way of monitoring incoming vehicles approaching from the rear which often leads to horrible accidents.

### BRIEF DESCRIPTION OF THE DRAWINGS

FIG. 1 is a flow chart of a method of warning a driver for an incoming vehicle approaching from the rear or both sides in accordance with the present invention;

FIG. 2 is a schematic view of an image capture unit combined with a wearable device in accordance with an embodiment of the present invention;

FIG. 3 is a schematic view of using Darknet to find the location of an object in a picture by a bounding box accurately, and marking the class of the object in accordance with the present invention;

FIG. 4 is a block diagram of a device of warning a driver for an incoming vehicle approaching from the rear or both sides in accordance with the present invention; and

FIG. 5 is a block diagram of a system of warning a driver for an incoming vehicle approaching from the rear or both sides of warning a driver for an incoming vehicle approaching from the rear or both sides in accordance with the present invention

### DESCRIPTION OF THE INVENTION

The aforementioned and other objects, characteristics and advantages of the present invention will become apparent with the detailed description of the preferred embodiments and the illustration of related drawings as follows.

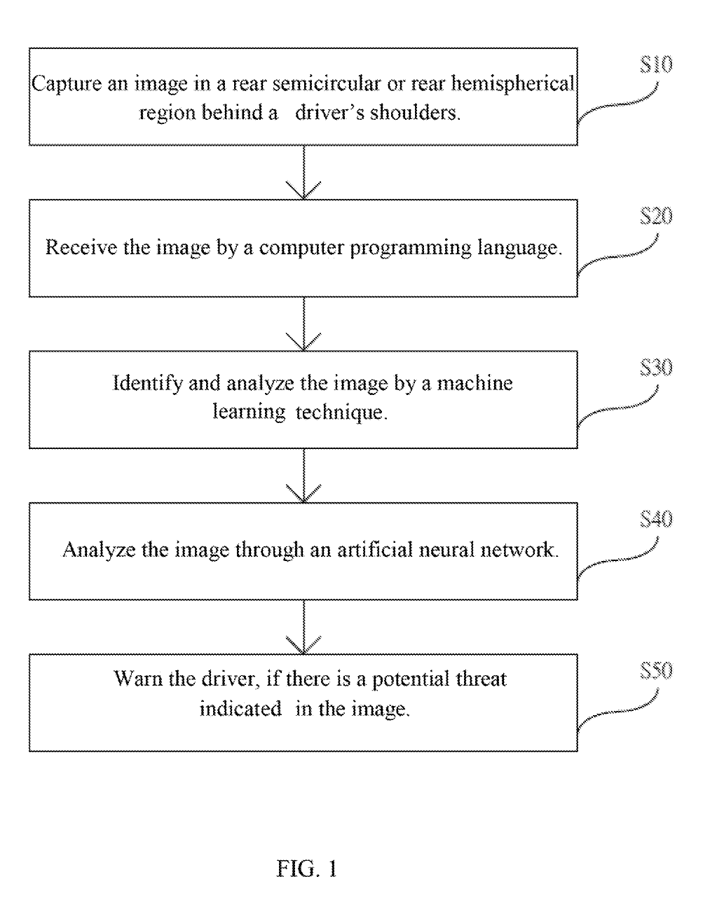

With reference to FIG. 1 for a flow chart of a method of warning a driver for an incoming vehicle approaching from the rear in accordance with the present invention, the method comprises the following steps (S10 to S50):

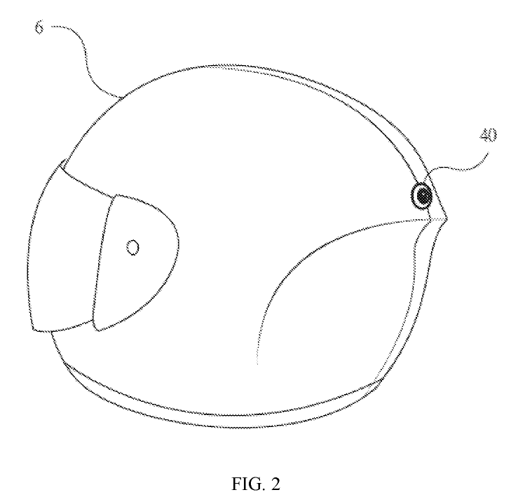

S10: Capture an image in a rear semicircular or rear hemispherical region behind a driver's shoulders. Specifically, an image capture unit permanently or temporarily combined with a wearable device is provided for capturing the image, wherein the angle of a lens of the image capture unit is at least 160 degrees, and the lens may face the rear of the driver. The device or system of the present invention may also be installed to a motor vehicle, and the lens faces the rear of the motor vehicle, wherein the wearable device may be clothing, a lace, a strap, a headwear, a Velcro tape, a wearable electronic device, etc. Specifically, the wearable device may be a safety helmet as shown in FIG. 2.

S20: Receive the image by a computer programming language, wherein the computer programming language may be a computer programming language used in a convolutional neural network (AlexNet) for deep learning in the field of artificial intelligence (AI) such as Python programming language. The Python programming language is an object-oriented interpreted computer programming language which includes a fully functional standard library capable of completing many common tasks. This language comes with simple syntax. Unlike most of other programming language requiring the use of brackets, the Python programming language simply uses indentation to define a block. The deep learning is a method based on the characteristics learning of data. An observation (such as an image) can be expressed in different ways such as the vector of a pixel intensity value or more abstractly a region including a series of column sides, a special shaped area, etc. Certain specific expression methods may be used to learn the task from cases easily (such as face recognition or facial expression recognition). The advantage of deep learning resides on its use of unsupervised or semi-supervised characteristic learning or hierarchical characteristic fetch high-performance algorithm to replace the manual method of obtaining the characteristics. The present invention also adopts any one of the major models of the convolutional neural network (CNN) such as AlexNet, VGGNet, Google Inception Net and/or ResNet, and the image received by the computer programming language converts the original image into a format used by the convolutional neural network.

S30: Identify and analyze the image by a machine learning technique. The machine learning technique is an open source software technique (TensorFlow) used in the machine learning of different perception and language interpretation tasks. At present, this technique has been used by 50 teams for the research and production of many Google products such as voice identification, Gmail, Google album, and search. Wherein, many products have used its former software DistBelief. In the algorithm of the open source software technique, Google needs to instruct a neural-network computer system, which is similar to the method of human learning and reasoning in order to assign new application programs, so as to undertake the roles and functions previously available to humans, and this algorithm is used for identifying and analyzing the image in the present invention. The name of TensorFlow comes from these neural networks executing the operation of multidimensional arrays. Such multidimensional arrays are called “Tensors”, but this concept is not equivalent to the mathematical concept of tensors. The purpose of TensorFlow is to train neural network detections and identify patterns and relationships.

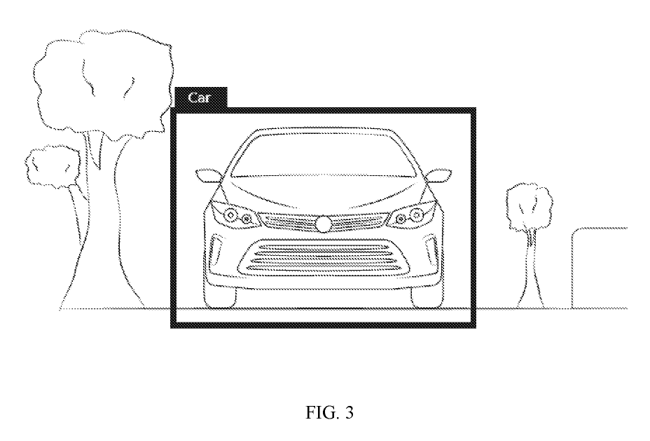

S40: Classify the image through an artificial neural network. The artificial neural network is Darknet which is an artificial neural network written in C and CUDA and used for target detection. The exact position of an object is located in an image accurately, and the type of the object is marked. The position of the object is generally marked by a bounding box, and one image may have several bounding boxes, and the target detection requires the information such as the type and probability of the object found within the bounding box as shown in FIG. 3. Compared with the AlexNet having more than 15,000,000 images, the Darknet only has several thousand images, so that Darknet is obviously more practical and faster in the use of predicting threats or classifying images.

S50: Determine whether or not there is a potential threat indicated in the image, and warn the driver if there is a threat indicated in the image. Specifically, the warning unit may generate an image, a sound, a vibration, or a smell to warn the driver. If the image is identified and analyzed to be including a motor vehicle in Step S30, then the motor vehicle in the image will be marked in the step S40 to warn the driver.

The present invention further comprises the step of determining whether or not a specific image (such as an image of boot, example, reference, etc.) is received within a time period (such as five seconds) before starting the step S10. If no such specific image has been received with the time period, then the steps of receiving the image and determining whether or not there is a potential threat, then the step S10 will be carried out.

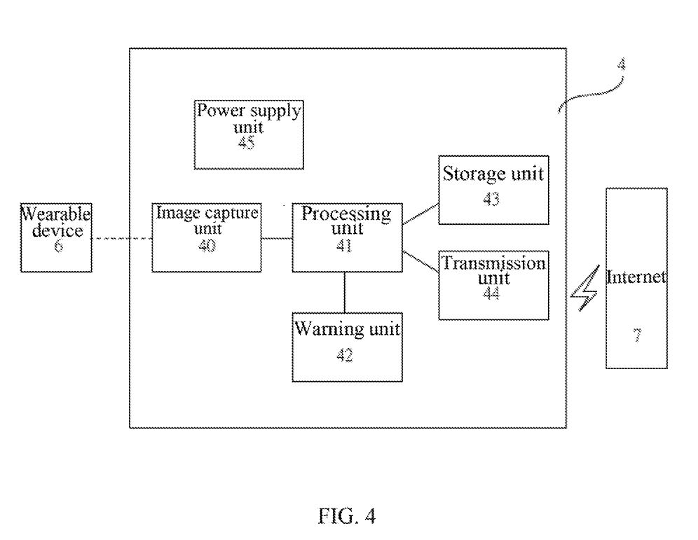

With reference to FIG. 4 for a block diagram of a device of warning a driver for an incoming vehicle approaching from the rear or both sides in accordance with the present invention, the device 4 comprises an image capture unit 40, a processing unit 41 and a warning unit 42.

The image capture unit 40 is provided for capturing an image in a rear semicircular or rear hemispherical region behind a driver's shoulders, wherein the image capture unit 40 is combined with a wearable device 6. The image capture unit 40 has been described in details in the step S10, and thus will not be repeated.

The processing unit 41 is coupled to the image capture unit 40, and provided for receiving the image by the computer programming language, identifying and analyzing the image by a machine learning technique, classifying the image through an artificial neural network, and analyzing whether or not there is a potential threat indicated in the image. Wherein, the computer programming language is one used in a convolutional neural network. Further, the computer programming language is Python programming language, and the machine learning technique is an open source software technique, and the artificial neural network is Darknet. These details have been described in Steps 20 to 50, and thus will not be repeated. The processing unit 41 may be a central processing unit (CPU), a microprocessor (MCU), a graphic processing unit, or a combination of the above.

The warning unit 42 is coupled to the processing unit 41 and provided for warning the driver. The warning unit 42 has been described in details in the step S50, and thus will not be repeated.

The device of warning a driver for an incoming vehicle approaching from the rear or both sides 4 according to the present invention further comprises a storage unit 43 coupled to the processing unit 41 for storing the computer programming language, the machine learning technique, the artificial neural network, the image or a combination of the above. The storage unit 43 may be an optical disk, a hard disk, a floppy disk, a universal serial bus (USB), etc. In the device of warning a driver for an incoming vehicle approaching from the rear or both sides 4 designed with a single-chip system, the storage unit 43 may be a static dynamic random access memory (SDRAM), a flash memory, an electrically erasable programmable read only memory (EEPROM), or an erasable programmable read only memory (EPROM).

The device of warning a driver for an incoming vehicle approaching from the rear or both sides 4 according to the present invention further comprises a transmission unit 44 coupled to the processing unit 41 and connected to the Internet 7 via wireless connection for storing the computer programming language, the machine learning technique, the artificial neural network, the image or a combination of the above through the Internet 7, transmitting the stored computer programming language, the machine learning technique, the artificial neural network, the image or a combination of the above to the processing unit 41 through the transmission unit 44. The Internet 7 may be connected through a mobile phone or a hotspot of other computers which may be a server, cloud computing, a supercomputer, or a host with a storage capacity.

If the processing unit 41 identifies and analyzes the image to be including a motor vehicle, then the processing unit 41 will mark the image and drive the warning unit 42 to warn the driver.

The device of warning a driver for an incoming vehicle approaching from the rear or both sides 4 according to the present invention further comprises a power supply unit 45 selectively coupled to the aforementioned units 40˜44 for the operation of the device of warning a driver for an incoming vehicle approaching from the rear or both sides 4.

It is noteworthy that the connection may be an electrical connection and/or an optical connection for transmitting signals or instructions. In addition, the aforementioned units 40˜45 may be integrated into a single chip if the device of warning a driver for an incoming vehicle approaching from the rear or both sides 4 is designed with a single-chip system.

In addition, the present invention further comprises an image capture unit 40 for capturing an image in a rear semicircular or rear hemispherical region behind the driver's shoulders, and the processing unit 41 determines whether or not a specific image (such as an image of boot, example, reference, etc.) has been received within a time period (such as five seconds). If no such specific image is received within the time period, then the steps of receiving the image and determining the receipt of the specific image will be repeated. If the specific image has been received within the time period, then the image in the rear semicircular or rear hemispherical region behind the driver's shoulders will be captured.

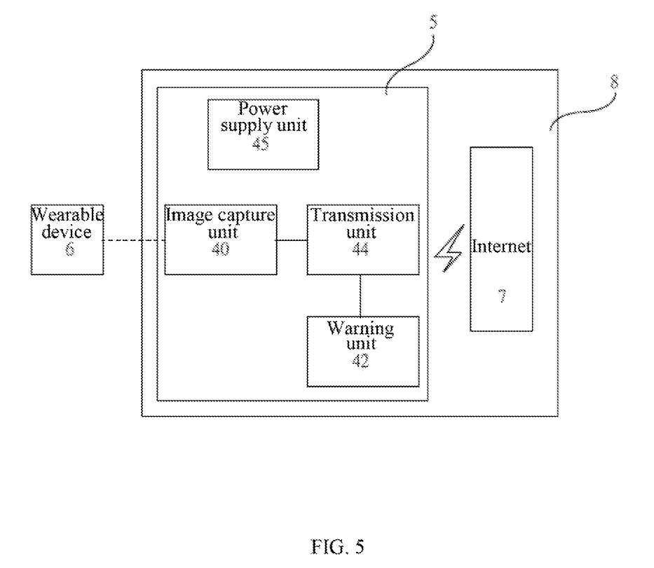

With reference to FIG. 5 for a block diagram of a system of warning a driver for an incoming vehicle approaching from the rear or both sides according to the present invention, the system 8 comprises a monitoring and warning device 5 and the Internet 7, and the monitoring and warning device 5 comprises an image capture unit 40, a transmission unit 44 and a warning unit 42.

The image capture unit 40 is provided for capturing an image in a rear semicircular or rear hemispherical region behind the driver's shoulders, and the image capture unit 40 is coupled to a wearable device 6.

The transmission unit 44 is coupled to an image capture unit 40 and connected to the Internet 7 through a hotspot or not through the hotspot, so that the image can be obtained through the Internet 7, wherein the image may be received through the Internet 7 by a computer programming language, and identified and analyzed by a machine learning technique, classified through an artificial neural network, and determined whether or not there is a potential threat indicated in the image. The Internet 7 may have a distributive computing structure of a server, clouding computing, a super computer, or a host with the computing and storage capabilities. Wherein, the computer programming language is one used in a convolutional neural network, and the computer programming language may be Python programming language, and the machine learning technique may be an open source software technique, and the artificial neural network may be Darknet. The aforementioned details have been described in the steps S20 to S50, and thus will not be repeated.

The warning unit 42 is coupled to the transmission unit 44 and provided for warning a driver when there is a threat indicated in the image which is analyzed through the Internet 7 and received by the transmission unit 44. Further, the image identified and analyzed by the Internet 7 indicates that there is a motorcycle or a threatening person or object included in the image, so that the image will be marked, and the warning unit 42 will warn the driver.

The monitoring and warning device 5 of the present invention further comprises a power supply unit 45 selectively coupled to the aforementioned units 40, 42 and 44 for supplying the power required for their operation. The power supply unit 45 may be a battery, an electrical terminal, a wireless charger, or a combination of the above. In addition, the monitoring and warning device 5 further comprises a storage unit coupled to the image capture unit 40 and the transmission unit 44 for storing the image, or provided for the transmission unit 44 to access the image.

The present invention further comprises determining whether or not there Internet has received a specific image (such as an image of boot, example, reference, etc.) within a period of time (such as five seconds) before the image capture unit 40 captures the image in the rear semicircular or rear hemispherical region behind the driver's shoulders. If it is determined that no such specific image has been received within the time period, then the steps of receiving and determining the image will be repeated. If it is determined that the specific image has been received within the time period, then the image in the rear semicircular or rear hemispherical region behind driver's shoulders will be captured.

In summation of the description above, the device or system of the present invention captures an image in the rear semicircular or rear hemispherical region behind the driver's shoulders, analyzes and identifies whether or not there is a potential threat by artificial intelligence to warn the driver automatically, so as to improve the driver's alert of incoming vehicles approaching from the rear as well as the driver's safety significantly. In addition, the Darknet used in the present invention provides a faster response for the prediction of threats or the classification of the image.

While the invention has been described by way of example and in terms of a preferred embodiment, it is to be understood that the invention is not limited thereto. To the contrary, it is intended to cover various modifications and similar arrangements and procedures, and the scope of the appended claims therefore should be accorded the broadest interpretation so as to encompass all such modifications and similar arrangements and procedures.

What is claimed is:

1. A device of warning a driver for an incoming vehicle approaching from the rear or both sides, comprising:
an image capture unit, for capturing an image in a rear semicircular or rear hemispherical region behind a driver's shoulders;
a processing unit, coupled to the image capture unit, for receiving the image by a computer programming language, identifying the image by a machine learning technique, analyzing the image, classifying the image through an artificial neural network, and analyzing whether or not the image is a threatening one; and
a warning unit, coupled to the processing unit, for warning the driver.

2. A system of warning a driver for an incoming vehicle approaching from the rear or both sides, comprising:
a monitoring and warning device, further comprising:
an image capture unit, for capturing an image in a rear semicircular or rear hemispherical region behind a driver's shoulders; and
a transmission unit, coupled to the image capture unit; a warning unit, coupled to the transmission unit, for warning the driver; and
the Internet, connected to the transmission unit via wireless connection, to obtain the image, and the Internet receiving the image by a computer programming language, identifying and analyzing the image by a machine learning technique, classifying the image through an artificial neural network, determining whether or not there is a potential threat indicated in the image, and the transmission unit transmitting a command to the warning unit to warn the driver when there is a threat indicated in the image.

3. The device of warning a driver for an incoming vehicle approaching from the rear or both sides according to claim 1, further comprising a storage unit coupled to the processing unit for storing the computer programming language, the machine learning technique, the artificial neural network, the image or a combination thereof.

4. The device of warning a driver for an incoming vehicle approaching from the rear or both sides according to claim 1, further comprising a transmission unit coupled to the processing unit and connected to the Internet via wireless connection for transmitting the stored computer programming language, the machine learning technique, the artificial neural network, and the image or a combination thereof to the processing unit.

5. The device of warning a driver for an incoming vehicle approaching from the rear or both sides according to claim 1, wherein the image capture unit is combined with a wearable device.

6. The device of warning a driver for an incoming vehicle approaching from the rear or both sides according to claim 2, wherein, the image capture unit is combined with a wearable device.

7. The device of warning a driver for an incoming vehicle approaching from the rear or both sides according to claim 1, wherein, the computer programming language is a Python programming language used in a convolutional neural network.

8. The system of warning a driver for an incoming vehicle approaching from the rear or both sides according to claim 2, wherein, the computer programming language is a Python programming language used in a convolutional neural network.

9. The device of warning a driver for an incoming vehicle approaching from the rear or both sides according to claim 1, wherein, the machine learning technique is an open source software technique.

10. The system of warning a driver for an incoming vehicle approaching from the rear or both sides according to claim 2, wherein, the machine learning technique is an open source software technique.

11. The device of warning a driver for an incoming vehicle approaching from the rear or both sides according to claim 1, wherein, the artificial neural network is Darknet.

12. The system of warning a driver for an incoming vehicle approaching from the rear or both sides according to claim 2, wherein, the artificial neural network is Darknet.

13. The device of warning a driver for an incoming vehicle approaching from the rear or both sides according to claim 1, wherein, the processing unit identifies and analyzes a motor vehicle included in the image, marks the image, and drives the warning unit to warn the driver.

14. The system of warning a driver for an incoming vehicle approaching from the rear or both sides according to claim 2, wherein, the Internet identifies and analyzed a motor vehicle in the image, marks the image, and drives the warning unit to warn the driver.
